(19) United States
(12) Patent Application Publication
(10) Pub. No.: US 2017/0327723 A1
(43) Pub. Date: Nov. 16, 2017

(54) WELLBORE FLUIDS FOR INCREASED WELLBORE STABILITY AND REDUCED TORQUE

(71) Applicant: M-I L.L.C., Houston, TX (US)

(72) Inventors: James Friedheim, Spring, TX (US); Gabriel Manescu, Katy, TX (US)

(21) Appl. No.: 15/151,910

(22) Filed: May 11, 2016

(51) Int. Cl. C09K 8/12; C09K 8/035; C09K 8/10

(52) U.S. Cl. CPC C09K 8/12; C09K 8/10; C09K 8/035; C09K 2208/12

(57) ABSTRACT

Wellbore fluids and methods of use thereof are disclosed. Wellbore fluids may include an aqueous base fluid, a rate of penetration enhancer, and a shale dispersion inhibitor, wherein the volume ratio of the rate of penetration enhancer to the shale dispersion inhibitor is greater than 1:1. Methods may include circulating the wellbore fluid into a wellbore.

### CROSS-REFERENCE TO RELATED APPLICATIONS

This application claims benefit of U.S. provisional application Ser. No. 62/159,449, filed May 11, 2015 and titled WELLBORE FLUIDS FOR INCREASED WELLBORE STABILITY AND REDUCED TORQUE, the entire disclosure of which is herein incorporated by reference.

### BACKGROUND

During the drilling of a wellbore, various fluids are used in the well for a variety of functions. The fluids may be circulated through a drill pipe and drill bit into the wellbore, and then may subsequently flow upward through wellbore to the surface. During this circulation, a drilling fluid may act to remove drill cuttings from the bottom of the hole to the surface, to suspend cuttings and weighting material when circulation is interrupted, to control subsurface pressures, to maintain the integrity of the wellbore until the well section is cased and cemented, to isolate the fluids from the formation by providing sufficient hydrostatic pressure to prevent the ingress of formation fluids into the wellbore, to cool and lubricate the drill string and bit, and/or to maximize penetration rate.

Water-based drilling fluids are often selected for use in a number of hydrocarbon plays, because of the lower associated cost and increased environmental compatibility as compared to oil-based drilling fluids often thought to be the first option in drilling operations. However, other concerns beyond cost effectiveness may also be involved in the selection of wellbore fluids, such as the type of formation through which the well is being drilled. For example, subterranean formations may be at least partly composed of reactive clays, including shales, mudstones, siltstones, and claystones, that swell in the presence of water.

When dry, clays may lack sufficient water for the constituent particles to adhere to each other, creating a region of friable and brittle solids. Conversely, in wet zones, the clays may be liquid-like with very little inherent strength, and may become unstable and mobile when contacted with a circulating wellbore fluid. In the intermediate stages between these extremes, clays may have the form of a sticky plastic solid with increased agglomeration properties and inherent strength. While drilling in clay-containing formations, operators may encounter a number of problems encountered that may include bit balling, swelling or sloughing of the wellbore, stuck pipe, and dispersion of drill cuttings into the surrounding wellbore fluid.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to wellbore fluids containing an aqueous base fluid, a ROP enhancer, and a shale dispersion inhibitor, wherein the volume ratio of the ROP enhancer to the shale dispersion inhibitor is greater than 1:1.

In another aspect, methods may include circulating a wellbore fluid into a wellbore, wherein the wellbore fluid contains an aqueous base fluid, a ROP enhancer, and a shale dispersion inhibitor, and wherein the volume ratio of the ROP enhancer to the shale dispersion inhibitor is greater than 1:1.

Other aspects and advantages of the claimed subject matter will be apparent from the following description and the appended claims.

### DETAILED DESCRIPTION

In one aspect, embodiments disclosed herein relate to water-based wellbore fluid compositions for use in formations containing reactive clays and other materials that may swell in the presence of aqueous fluids. Wellbore fluids in accordance with the present disclosure may be formulated to include rate of penetration (ROP) enhancers that improve drilling speed and reduce torque. Further, wellbore fluids may also combine ROP enhancers with a shale inhibitor at select ratios that promote retention of the wellbore fluid within the wellbore and prevent fluid loss due to absorption by clays and other hydrophilic minerals. In some embodiments, the combination of ROP enhancer and shale inhibitor may stabilize clay-containing formations and inhibit the dispersion of clay cuttings, reducing formation damage and undesirable changes in wellbore fluid rheology.

While most of the terms used herein will be recognizable to those of skill in the art, the following definitions are put forth to aid in the understanding of the present disclosure. It should be understood, however, that when not explicitly defined, terms should be interpreted as adopting a meaning presently accepted by those of skill in the art.

The term “alkyl” as used herein, unless otherwise specified, refers to a saturated straight chain, branched or cyclic hydrocarbon group in particular embodiments. The hydrocarbon group may be selected from, for example, methyl, ethyl, n-propyl, isopropyl, n-butyl, isobutyl, sec-butyl, t-butyl, pentyl, cyclopentyl, isopentyl, neopentyl, hexyl, isohexyl, cyclohexyl, 3-methylpentyl, 2,2-dimethylbutyl, and 2,3-dimethylbutyl. The term “cycloalkyl” refers to cyclic alkyl groups such as cyclopropyl, cyclobutyl, cyclopentyl, cyclohexyl, cycloheptyl and cyclooctyl.

Moreover, the term “alkyl” includes “modified alkyl”, which references an alkyl group having from one to twenty-four carbon atoms, and further having additional groups, such as one or more linkages selected from ether-, thio-, amino-, phospho-, oxo-, ester-, and amido-, and/or being substituted with one or more additional groups including lower alkyl, phenyl, polycyclic alkyl, polycyclic aromatics, alkoxy, thioalkyl, hydroxyl, amino, sulfonyl, thio, mercapto, imino, halo, cyano, nitro, nitroso, azide, carboxy, sulfide, sulfone, sulfoxy, phosphoryl, silyl, silyloxy, and boronyl.

The term “alkoxy” as used herein refers to a substituent —O—R wherein R is alkyl as defined above. The term “lower alkoxy” refers to such a group wherein R is lower alkyl. The term “thioalkyl” as used herein refers to a substituent —S—R wherein R is alkyl as defined above. The term “alkoxy ether” as used herein, refers to a substituent —O—(R₁—O)ₓ—R₂, wherein R₁ and R₂ are independently alkyl groups as defined above, and where X may be any integer between 1 and 10.

The term “alkylene” as used herein, unless otherwise specified, refers to a bivalent saturated alkyl chain (such as ethylene) regarded as derived from an alkene by opening of the double bond or from an alkane by removal of two hydrogen atoms from different carbon atoms.

The term “alkenyl” as used herein, unless otherwise specified, refers to a branched, unbranched or cyclic (e.g. in the case of C5 and C6) hydrocarbon group of 2 to 30, or 2 to 12 in some embodiments, carbon atoms containing at least one double bond, such as ethenyl, vinyl, allyl, octenyl, decenyl, dodecenyl, and the like. The term “lower alkenyl” intends an alkenyl group of two to eight carbon atoms, and specifically includes vinyl and allyl. The term “cycloalkenyl” refers to cyclic alkenyl groups.

Inhibition of Shale Hydration

Wellbore operations in shale and other clay-containing formations may face adverse conditions when clays downhole swell in the presence of aqueous wellbore fluids. For example, bit balling occurs when cutting stick to the bit surface in water reactive formations, which may cause drilling equipment to skid on the bottom of the hole preventing it from penetrating uncut rock, therefore slowing the rate of penetration. Furthermore, the overall increase in bulk volume accompanying clay swelling impacts the stability of the borehole, increases friction between the drill bit and the sides of the borehole, and inhibits wellbore fluid additive buildup, or filter cake, that seals the formation and decreases wellbore fluid penetration.

Clay minerals encountered in subterranean formations are often crystalline in nature, which can dictate the response observed when exposed to wellbore fluids. Clays may have a flaky, mica-type structure made up of crystal platelets stacked face-to-face. Each platelet is defined as a unit layer, and the surfaces of the unit layer are basal surfaces. Each unit layer is composed of multiple sheets, which may include octahedral sheets and tetrahedral sheets. Octahedral sheets are composed of either aluminum or magnesium atoms octahedrally coordinated with the oxygen atoms of hydroxyls, whereas tetrahedral sheets contain silicon atoms tetrahedrally coordinated with oxygen atoms.

In clay mineral crystals, atoms having different valences may be positioned within the sheets of the structure to create a negative potential at the crystal surface, which causes cations to be adsorbed thereto. These adsorbed cations are called exchangeable cations because they may chemically trade places with other cations when the clay crystal is suspended in water. In addition, ions may also be adsorbed on the clay crystal edges and exchange with other ions in the water.

The clay crystal structure and the exchangeable cations adsorbed on the crystal surface can affect clay swelling. Clay swelling is the phenomenon in which water molecules surround a clay crystal structure and position themselves to increase the structure's d-spacing, which results in a measurable increase in volume. Two types of swelling may occur: surface hydration and osmotic swelling.

Surface hydration is one type of swelling in which water molecules are adsorbed on crystal surfaces. Hydrogen bonding holds a layer of water molecules to the oxygen atoms exposed on the crystal surfaces. Subsequent layers of water molecules align to form a quasi-crystalline structure between unit layers, which results in an increased d-spacing. Virtually all types of clays swell in this manner.

Osmotic swelling is another type of swelling observed in clays. Where the concentration of cations between unit layers in a clay mineral is higher than the cation concentration in the surrounding water, water is osmotically drawn between the unit layers and the d-spacing is increased. Osmotic swelling results in larger overall volume increases than surface hydration, and only a limited number of clays, like sodium montmorillonite, swell in this manner.

In one or more embodiments, clay swelling may be inhibited through the use of a combination of ROP enhancers and shale inhibitors that may reduce swelling and reactivity of clays when conducting wellbore operations in clay-containing formations. While not limited by any particular theory, it is believed that increasing the concentration of ROP enhancer with respect to a shale inhibitor component within wellbore fluid results in a favorable modification of the ability of the wellbore fluid to reduce water penetration and clay swelling.

In some embodiments, wellbore fluids may include an aqueous base fluid, an ROP enhancer, a shale inhibitor, and other wellbore fluid additives such as an encapsulating agent that may be present depending on the particular application. Wellbore fluids in accordance with the present disclosure may be used in shale formations or formations containing regions of intercalated clay during drilling operations, specialty applications as displacement fluids, used in pill formulations, and during completions. In particular embodiments, wellbore fluids of the present disclosure may be used in drilling a horizontal section of a well containing intercalated clay and may do so in manner that increases the ROP to near or even better than what would be achieved with an oil-based fluid.

ROP Enhancers

Wellbore fluids in accordance with embodiments of the present disclosure may include rate of penetration (ROP) enhancers that reduce accretion of cuttings onto a drill bit, and enhance penetration rates the when drilling through reactive clay-containing formations. While structure for ROP enhancers may vary, the chemical structure may be categorized as having a hydrophobic portion that associates with clays and other surfaces and a hydrophilic portion that increases the solubility of the molecule in aqueous solutions.

In one or more embodiments, the ROP enhancer may be a fatty acid including fatty acids derived from natural fats and oils. For example, tall-oil fatty acids are distilled from conifer trees. Animal and vegetable fats and oils may be hydrolyzed to give fatty acids. Fatty acids from animals are mostly saturated acids, having single bonds between carbon atoms. Tall oils and vegetable oils yield both saturated and unsaturated (double- and triple-bond) fatty acids.

In some embodiments, suitable fatty acids may also include cyclic and aromatic fatty acids such as abietic acid, palmiric acid, and other acids derived from natural sources. In one or more embodiments, the ROP enhancer may include fatty acids having the general formula XR¹R², where X may be a counter ion such as an alkaline or alkali metal, ammonium, or be a covalent hydrogen; R¹ is an acidic functional group capable of forming an anion such as a carboxylic acid or a sulfate group, and R² is an alkyl, phenyl alkyl, cycloalkyl, polycyclic alkyl, or polycyclic aromatic alkyl group having 3-22 carbon atoms.

ROP enhancers in accordance with the present disclosure may also be a fatty acid selected from butyric acid, valeric acid, caproic acid, enanthic acid, caprylic acid, pelargonic acid, capric acid, lauric acid, myristic acid, palmitic acid, stearic acid, in addition to unsaturated fatty acids such as myristoleic acid, palmitoleic acid, oleic acid, linoleic acid, alpha-linoleic acid, erucic acid, and the like. In addition to these fatty acids, the compounds may also have a small degree of substitution and/or branching, or may be sulfonic or phosphonic derivatives thereof. In some embodiments, ROP enhancers may be selected from commercial reagents such as HYDRASPEED™, available from M-I L.L.C. (Houston, Tex.).

In one or more embodiments, the field concentration of ROP enhancer may be from 0.5% to 5% by volume of the wellbore fluid. The concentration of ROP enhancer may be from 1.5% to 4.5% by volume of the wellbore fluid in some embodiments, and from 2% to 4% by volume of the wellbore fluid in yet other embodiments.

Shale Inhibitors

Wellbore fluids in accordance with the present disclosure may also contain shale inhibitors that reduce clay dispersion, stabilizing the clay particles and preventing formation damage and dissolution that would otherwise alter the wellbore fluid composition and rheology. Further, shale inhibitors may decrease or eliminate water uptake by reactive shales, thereby preventing fluid loss to clay-rich formations.

In one or more embodiments, shale inhibitors may include alkyl amines containing one or more amino groups, and oligomers and polymers of amino-substituted compounds. In some embodiments, suitable alkyl amines may be molecules containing one or more amino groups that may be primary, secondary, tertiary, or quaternary. In some embodiments, alkyl amines may have of varying levels of alkyl substitution including, for example, tertiary amines such as trimethylamine and triethylamine, and tetra-substituted alkyl amines such as alkyl quaternary ammonium compounds typified by tetraethylammonium, tetrabutylammonium, choline, and the like; and alkylbenzyl quaternary ammonium compounds including one or more alkyl chains and one or more aromatic groups such as benzyltrimethylammonium, benzyltriethylammonium, and the like.

In some embodiments, the shale inhibitor may be a difunctional primary amine [H₂N—R—NH₂] such as butylene diamine, pentamethylene diamine, hexamethylene diamine, difunctional secondary and tertiary diamines, and the like. Shale inhibitors may also include alkyl quaternary ammonium compounds having alkyl substituents independently selected from alkyl chain lengths ranging from 1 to 6 carbons in length, aromatic groups such as benzyl or phenyl groups, hydroxyl-substituted alkyl, and cycloalkyl groups such as cyclopentyl or cyclohexyl. For example, shale inhibitors may include mixed alkyl quaternary amines prepared from the reaction of trihydroxyalkyl amines with various alkyl halides.

Suitable shale inhibitors also include polyamines having two or more amino groups, at least one of which is present in an alkyl chain, such as a polyalkylene amine, and polyamines containing two or more amino groups as pendant groups from an alkyl chain, such as a polyallylamine. Amino groups in the polyamines may be primary, secondary, tertiary, or quaternary. Polyamines in accordance with the present disclosure may include spermine, spermidine, amidine, protamine, 1,6-diaminocyclohexane, cyclic amines including piperazine, cyclen, and the like.

Shale inhibitors in accordance with the present disclosure may also include polyether amines and polyalkylene amines. In one or more embodiments, polyamines may be a polyetheramine such as those commercially available under the trade name JEFFAMINE® from Huntsman Performance Products (Woodlands, Tex.). For example, JEFFAMINE® products may include triamines JEFFAMINE® T-5000 and JEFFAMINE® T-3000, and diamines such as JEFFAMINE® D-400, D-230, and D-2000. In some embodiments, polyamine additives may be selected from commercial shale inhibitors such as ULTRAHIB™, KLASTOP™, KLAGARD™, KLACURE™, HYDRAHIB™, HIB 933™, and KLAHIB™, available from M-I L.L.C. (Houston, Tex.).

Shale inhibitors of the present disclosure may be combined with a wellbore fluid in concentrations sufficient to inhibit clay swelling for a particular formation in a given geographic region. In one or more embodiments, the field concentration of shale inhibitor may be from 0.5% to 5% by volume of the wellbore fluid. In other embodiments, the concentration of shale inhibitor may be from 1% to 3% by volume of the wellbore fluid.

Shale hydration rates may depend in part on the pH of the wellbore fluid. At elevated pH, shale hydration may occur more rapidly than at lower pH, and shale inhibitors may be selected to minimize this effect. In some embodiments, shale inhibitors may be amino-containing compounds having reduced basicity such that addition of these compounds to a wellbore fluid maintains the pH within a weakly basic range. In some embodiments, the shale inhibitor may maintain the pH of the wellbore fluid in the pH range of pH 8 to pH 12. In some embodiments, the shale inhibitor may maintain the pH of the wellbore fluid in the pH range of pH 8.5 to pH 11.

In one or more embodiments, a wellbore fluid may be formulated such that the volume ratio of the ROP enhancer to the shale dispersion inhibitor is greater than 1:1. As used herein “volume ratio of the ROP enhancer to the shale dispersion inhibitor is greater than 1:1” is used to indicate that in all wellbore fluid formulations, the volume ratio of the concentration of the ROP enhancer by volume is greater relative to the concentration of the shale inhibitor by volume in a given wellbore fluid formulations. For example, the ratio of the ROP enhancer to the shale inhibitor may be 1.01:1, 2:1, 3:1, etc.

Encapsulating Agent

In one or more embodiments, wellbore fluids may contain an encapsulating agent selected from the group of synthetic organic, inorganic and bio-polymers and mixtures thereof. The role of the encapsulating agent is to absorb at multiple points along the chain onto the clay particles, thus binding the particles together and encapsulating the cuttings. These encapsulating agents help improve the removal of cuttings with less dispersion of the cuttings into the drilling fluids. The encapsulating agents may be anionic, cationic, amphoteric, or non-ionic in nature and may also include larger molecular weight polymers that remedy fluid loss and decrease formation permeability

Encapsulating agents in accordance with the present disclosure may include polymers, copolymers, block copolymers, and higher order copolymers (i.e., a terpolymer or quaternary polymer, etc.) composed of monomers that may include 2-acrylamido-2-methylpropanesulfonate, acrylamide, acrylic acid, methacrylic acid, diallyldimethyl ammonium chloride, methacrylamide, N,N dimethyl acrylamide, N,N dimethyl methacrylamide, tetrafluoroethylene, dimethylaminopropyl methacrylamide, N-vinyl-2-pyrrolidone, N-vinyl-3-methyl-2-pyrrolidone, N-vinyl-4,4-diethyl-2-pyrrolidone, 5-isobutyl-2-pyrrolidone, N-vinyl-3-methyl-2-pyrrolidone, alkyl oxazoline, poly(2-ethyl-2-oxazoline), C₂-C₁₂ olefins, ethylene, propylene, butene, butadiene, vinyl aromatics, styrene, alkylstyrene, vinyl alcohol, partially hydrolyzed acrylamide or methacrylamide, and derivatives or mixtures thereof.

In some embodiments, polyamine shale inhibitors may include copolymers of acrylamide-type comonomers and at least one cationic amino-containing comonomer (e.g., diallyldimethyl ammonium chloride, DADMAC). In yet other embodiments, encapsulating agents may also include polylysine, cationic polymers such as polyallylamine, polyethyleneimine (PEI), polydiallyldimethylammonium halide, chitosan, or mixtures of polyamines.

In one or more embodiments, the encapsulating agent may include polyacrylates having varying levels of alkoxy substitution, such as 5% to 50% of the available carboxylate moieties of the polyacrylate, including hydroxyethyl acrylate, hydroxypropyl acrylate (HPA), and the like. Encapsulating agents may also include anionic wellbore fluid additives such as polyanionic carboxymethylcellulose (PAC), partially-hydrolyzed polyacrylamides (PHPA), and the like. In some embodiments, encapsulating agents may be selected from commercial reagents such as POLYPLUS™ LV, ULTRACAP™, IDCAP™ D, HYDRACAP™ and KLACAP™, all of which are available from M-I L.L.C. (Houston, Tex.).

Wellbore fluids in accordance with embodiments disclosed herein may contain encapsulating agents in an amount ranging from 0.5 to 5 pounds per barrel; however, more or less may be used depending on the characteristics of the particular formation and the composition of the selected fluid.

Wellbore Fluids

Wellbore fluids may contain a base fluid that is entirely aqueous base or contains a full or partial oil-in-water emulsion. In some embodiments, the wellbore fluid may be any water-based fluid that is compatible with the shale hydration inhibition agents disclosed herein. In some embodiments, the fluid may include at least one of fresh water, mixtures of water and water soluble organic compounds and mixtures thereof.

In various embodiments, the wellbore fluid may contain a brine such as seawater, aqueous solutions wherein the salt concentration is less than that of sea water, or aqueous solutions wherein the salt concentration is greater than that of sea water. Salts that may be found in seawater include, but are not limited to, sodium, calcium, aluminum, magnesium, potassium, strontium, lithium, and salts of chlorides, bromides, carbonates, iodides, chlorates, bromates, formates, nitrates, oxides, sulfates, phosphates, silicates and fluorides. Salts that may be incorporated in a given brine include any one or more of those present in natural seawater or any other organic or inorganic dissolved salts. Additionally, brines that may be used in the drilling fluids disclosed herein may be natural or synthetic, with synthetic brines tending to be much simpler in constitution. One of ordinary skill would appreciate that the above salts may be present in the base fluid or may be added according to the method disclosed herein. Further, the amount of the aqueous based continuous phase should be sufficient to form a water based drilling fluid. This amount may range from nearly 100% of the wellbore fluid to less than 30% of the wellbore fluid by volume. In some embodiments, the aqueous based continuous phase may constitute from about 95 to about 30% by volume or from about 90 to about 40% by volume of the wellbore fluid.

Wellbore Fluid Additives

The wellbore fluids may also include viscosifying agents in order to alter or maintain the viscosity and potential changes in viscosity of the drilling fluid. Viscosity control may be needed in some scenarios in which a subterranean formation contains varying temperature zones. For example, a wellbore fluid may undergo temperature extremes of nearly freezing temperatures to nearly the boiling temperature of water or higher during the course of its transit from the surface to the drill bit and back.

Viscosifying agents suitable for use in the formulation of the fluids of the present disclosure may be generally selected from any type of natural biopolymer suitable for use in aqueous based drilling fluids. Biopolymers may include starches, celluloses, and various gums, such as xanthan gum, gellan gum, welan gum, and schleroglucan gum. Such starches may include potato starch, corn starch, tapioca starch, wheat starch and rice starch, etc. In accordance with various embodiments of the present disclosure, the biopolymer viscosifying agents may be unmodified (i.e., without derivitization). Polymeric viscosifiers may include, for example, POLYPAC® UL polyanionic cellulose (PAC), DUOVIS®, and BIOVIS®, each available from M-I L.L.C. (Houston, Tex.).

Moreover, the wellbore fluids of the present disclosure may include a weight material or weighting agent in order to increase the density of the fluid. The primary purpose for such weighting materials is to increase the density of the fluid so as to prevent kick-backs and blow-outs. Thus the weighting agent may be added to the drilling fluid in a functionally effective amount largely dependent on the nature of the formation being drilled. Weighting agents or density materials suitable for use the fluids disclosed herein include the salts used to form the brine used as the base fluid, as well as solid weighting agents such as galena, hematite, magnetite, iron oxides, illmenite, barite, siderite, celestite, dolomite, calcite, and the like, mixtures and combinations of these compounds and similar such weight materials that may be used in the formulation of wellbore fluids. The quantity of such material added, if any, may depend upon the desired density of the final composition.

In certain embodiments, the methods of the present disclosure may include providing a wellbore fluid (e.g., a drilling fluid, reservoir drill-in fluid, fracturing fluid, etc.) that contains an aqueous base fluid, a ROP enhancer, and a shale inhibitor, and placing the wellbore fluid in a subterranean formation. The selected additives may be mixed into the wellbore fluid individually or as a multi-component additive that contains ROP enhancer and shale inhibitor, and/or other components. The additives may be added to the wellbore fluid prior to, during, or subsequent to placing the wellbore fluid in the subterranean formation.

A wellbore fluid according to the disclosure may be used in a method for drilling a well into a subterranean formation in a manner similar to those wherein conventional wellbore fluids are used. In the process of drilling the well, a wellbore fluid is circulated through the drill pipe, through the bit, and up the annular space between the pipe and the formation or steel casing to the surface. The wellbore fluid performs several different functions, such as cooling the bit, removing drilled cuttings from the bottom of the hole, suspending the cuttings and weighting the material when the circulation is interrupted.

The ROP enhancer and shale inhibitor may be added to a base fluid on location at a well-site where it is to be used, or it can be carried out at another location than the well-site. If the well-site location is selected for carrying out this step, the ROP enhancer and shale inhibitor may be dispersed in an aqueous fluid, and the resulting wellbore fluid may be emplaced in the well using techniques known in the art.

Another embodiment of the present method includes a method of reducing the swelling of shale in a well whereby a water-base fluid formulated in accordance with the teachings of this disclosure is circulated in a well. The methods and fluids of the present disclosure may be utilized in a variety of subterranean operations that involve drilling, drilling-in (without displacement of the fluid for completion operations), and fracturing. Examples of suitable subterranean drilling operations include, but are not limited to, water well drilling, oil/gas well drilling, utilities drilling, tunneling, construction/installation of subterranean pipelines and service lines, and the like. In some embodiments, wellbore fluids in accordance with the present disclosure may be used to stimulate the fluid production.

While the disclosure includes a limited number of embodiments, those skilled in the art, having benefit of this disclosure, will appreciate that other embodiments may be devised which do not depart from the scope of the present disclosure. Accordingly, the scope should be limited only by the attached claims. Moreover, embodiments described herein may be practiced in the absence of any element that is not specifically disclosed herein.

In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. §112(f) for any limitations of any of the claims herein, except for those in which the claim expressly uses the words ‘means for’ together with an associated function.

What is claimed:

1. A wellbore fluid, comprising:
an aqueous base fluid;
a ROP enhancer; and
a shale dispersion inhibitor, wherein the volume ratio of the ROP enhancer to the shale dispersion inhibitor is greater than 1:1.

2. The wellbore fluid of claim 1, wherein the volume ratio of the penetration enhancing agent to the shale dispersion inhibitor is within the range of greater than 1:1 to 3:1.

3. The wellbore fluid of claim 1, wherein the ROP enhancer is one or more selected from the group of fatty acids having the formula XR¹R², where X may be a counter ion such as an alkaline or alkali metal, ammonium, or be a covalent hydrogen; R¹ is a carboxylic acid or a sulfate group, and R² is an alkyl, phenyl alkyl, cycloalkyl, polycyclic alkyl, or polycyclic aromatic alkyl group having 3-22 carbon atoms.

4. The wellbore fluid of claim 1, wherein the ROP enhancer is a tall-oil fatty acid.

5. The wellbore fluid of claim 1, wherein the shale dispersion inhibitor is one or more selected from the group of alkyl amines, polyamines, polyether amines, and polyalkylene amines.

6. The wellbore fluid of claim 1, further comprising an encapsulating agent.

7. The wellbore fluid of claim 6, wherein the encapsulating agent is one or more selected from the group of hydroxyethyl acrylate, hydroxypropyl acrylate, polyanionic carboxymethylcellulose, partially-hydrolyzed polyacrylamides, and copolymers of acrylamide and a cationic amino-containing comonomer.

8. The method of claim 6, wherein the encapsulating agent is present at a concentration ranging from 0.5 to 5 pounds per barrel.

9. The wellbore fluid of claim 1, wherein the pH of the wellbore fluid is in the pH range of pH 8.5 to pH 11.

10. A method of drilling, comprising:
circulating a wellbore fluid into a wellbore, the wellbore fluid comprising:
an aqueous base fluid;
a ROP enhancer; and
a shale dispersion inhibitor, wherein the volume ratio of the ROP enhancer to the shale dispersion inhibitor is greater than 1:1.

11. The method of claim 10, wherein the volume ratio of the penetration enhancing agent to the shale dispersion inhibitor is within the range of greater than 1:1 to 3:1.

12. The method of claim 10, wherein the ROP enhancer is one or more selected from the group of fatty acids having the formula XR¹R², where X may be a counter ion such as an alkaline or alkali metal, ammonium, or be a covalent hydrogen; R¹ is a carboxylic acid or a sulfate group, and R² is an alkyl, phenyl alkyl, cycloalkyl, polycyclic alkyl, or polycyclic aromatic alkyl group having 3-22 carbon atoms.

13. The method of claim 10, wherein the ROP enhancer is a tall-oil fatty acid.

14. The method of claim 10, wherein the shale dispersion inhibitor is one or more selected from the group of wherein the shale dispersion inhibitor is one or more selected from the group of alkyl amines, polyamines, polyether amines, and polyalkylene amines.

15. The method of claim 10, further comprising an encapsulating agent.

16. The method of claim 15, wherein the encapsulating agent is one or more selected from the group of hydroxyethyl acrylate, hydroxypropyl acrylate, polyanionic carboxymethylcellulose, partially-hydrolyzed polyacrylamides, and copolymers of acrylamide and a cationic amino-containing comonomer.

17. The method of claim 15, wherein the encapsulating agent is present at a concentration ranging from 0.5 to 5 pounds per barrel.

18. The method of claim 10, wherein the pH of the wellbore fluid is in the pH range of pH 8.5 to pH 11.

19. The method of claim 10, wherein the wellbore fluid is used as a displacement fluid.

20. The method of claim 10, wherein the wellbore fluid is injected as a pill.
